(19) United States
(12) Patent Application Publication
(10) Pub. No.: US 2026/0043274 A1
(43) Pub. Date: Feb. 12, 2026

(54) LOW-POWER ELECTRIC DOOR STRIKE INCLUDING DUAL LOCKING MECHANISM

(71) Applicant: Hanchett Entry Systems, Inc., Phoenix, AZ (US)

(72) Inventors: Stephanie Delgado, Zapopan (MX); Gerardo Alvarez Tostado, Chapala (MX); Matt Branson, Mesa, AZ (US); Joshua T. Peabody, Phoenix, AZ (US)

(73) Assignee: Hanchett Entry Systems, Inc., Phoenix, AZ (US)

(21) Appl. No.: 19/293,019

(22) Filed: Aug. 7, 2025

Related U.S. Application Data
(60) Provisional application No. 63/681,591, filed on Aug. 9, 2024.

(51) Int. Cl. E05B 63/24; E05B 15/04

(52) U.S. Cl. CPC E05B 63/248; E05B 2015/0496

(57) ABSTRACT

A locking mechanism associated with a keeper of an electric strike is provided. The mechanism comprises a dual shaft actuator, first and second worm cams coupled to respective shafts, and first and second plungers. A first end portion of first and second resilient members are operably engaged with first and second worm cams, and a second end portion is fixedly coupled with respective first and second plungers. When the actuator rotates the shafts in a first rotational direction, the first and second worm gears move the first and second resilient members toward one another to place the first and the second plungers in a retracted position. When the actuator rotates the first and second shafts in a second rotational direction, the first and second worm gears move the first and second resilient members away from one another to thereby place the first and second plungers in an extended position.

### CROSS-REFERENCE TO RELATED APPLICATIONS

This application claims the benefit of U.S. Patent Application No. 63/681,591 filed on Aug. 9, 2024, the contents of which are incorporated by reference in its entirety.

### TECHNICAL FIELD

The present invention relates to an electric door strike for selectively securing a door in a door frame; and particularly, to a low-power electric door strike comprising a dual locking mechanism including a dual shaft motor and two opposing plungers that operate to selectively place a keeper in a locked state to retain a door latch in a strike cavity and thereby maintain the door in a closed position within the door frame; and more particularly, the electric door strike includes at least one capacitor that enables the locking mechanism to move to its starting position in each cycle and in the case of a power failure, and a mode selector that allows the electric door strike to be switched between fail-safe and fail-secure modes of operation.

### BACKGROUND OF THE INVENTION

It is common for a door to include a door latch that is selectively secured within a door frame using an electric door strike. In particular, the electric door strike may include a keeper that is configured to retain the door latch within a strike cavity. When the door latch is retained within the strike cavity by the keeper, the door is prevented from moving to an open position relative to the door frame. In a fail-secure mode of operation, the door is secured relative to the door frame in the event of a power failure by a locking mechanism that causes the keeper to remain in a locked state relative to the strike cavity in the case of power failure. In a fail-safe mode of operation, a power failure results in a release of the keeper relative to the strike cavity thereby allowing the door latch to be removed from the strike cavity as the door is opened relative to the door frame.

One type of existing electric door strike is the HES 1006 Series Electric Strike offered by ASSA ABLOY. This particular electric door strike includes at least one solenoid integrated into the keeper to provide engagement between opposing plungers and the strike cavity to place the keeper in the locked state relative to the strike cavity. The use of opposing plungers to engage the strike housing provides a solution for securing the keeper in its locked state to reduce the likelihood of a forced entry. However, in certain applications, it may be necessary to replace this type of electric door strike in order to change between the fail-safe and fair-secure modes of operation. Furthermore, when this type of electric strike is powered under continuous duty for extended periods of time, the dual solenoid design may require a significant amount of power.

What is needed is an electric door strike that utilizes a relatively low amount of power during operation. What is also needed is an electric strike that can readily change between fail-safe and fail-secure modes of operation without having to modify the assembly or have two different designs. What is also needed is an electric door strike that is capable of returning to its original state in the case of a power failure. It is an aspect of the present invention to provide an electric door strike assembly that fulfills these needs as well as other needs.

### SUMMARY OF THE INVENTION

Briefly described, one exemplary embodiment of an electric door strike is provided. The electric door strike may comprise a housing including an inner wall defining a first cavity configured for receiving the latch, and a first recess and a second recess defined in the inner wall. The electric strike further comprises a keeper mounted to the housing and movable between a closed position and an opened position, wherein the keeper is configured for retaining the latch in the first cavity when in the closed position. Further, a locking mechanism is coupled to the keeper and comprises an outer body including a first end and a second end, wherein the outer body defines a second cavity, and includes a first opening defined in the first end and a second opening defined in the second end. An actuator is disposed within the second cavity and includes at least one shaft, such as a first shaft and a second shaft, wherein the actuator is configured for rotating the first shaft and the second shaft. First and second worm cams are coupled with the first shaft. The locking mechanism further includes a first and second plungers, as well as first and second resilient members. The first resilient member has first and second end portions, and is movably positioned within the first opening. The first end portion of the first resilient member is operably engaged with the first worm cam, and the second end portion of the first resilient member is fixedly coupled with the first plunger. The second resilient member has first and second end portions, and is movably positioned in the second opening. The first end portion of the second resilient member is operably engaged with the second worm cam, and the second end portion of the second resilient member is fixedly coupled with the second plunger. When the actuator rotates the first and second shafts in a first rotational direction, the first worm gear and the second worm gear move the respective first and second resilient members toward one another to thereby place the first plunger and the second plunger in a retracted position so that the first and second plungers are not engaged with the respective first and second recesses to thereby allow the keeper to move to the opened position when the latch is moved out of the first cavity. When the actuator rotates the first and second shafts in a second rotational direction opposite of the first rotational direction, the first and second worm gears move the respective first and second resilient members away from one another to thereby place the first and second plungers in an extended position so that the first and second plungers are in a position to engage with the respective first and second recesses to maintain the keeper in the closed position.

In another aspect, a method of operating an electric strike as described above for use in conjunction with a latch of a lockset is provided. The method includes: a) providing the locking mechanism coupled with the keeper; b) rotating the first and second shafts in a first rotational direction using the actuator to thereby rotate the first worm cam and the second worm cam, respectively, in the first rotational direction; and c) moving the first resilient member and the second resilient member along a linear path away from each other to move the first and second plungers in an extended position to engage the keeper with the housing to maintain the keeper in the closed position. The method may further comprise the steps of rotating the first and second shafts in a second rotational direction using the actuator to thereby rotate the first and second worm cams, respectively, in the second rotational direction, wherein the second rotational direction is opposite of the first rotational direction; and moving the first and second resilient members along the linear path towards each other to move the first and second plungers in a retracted position to disengage the keeper from the housing and allow the keeper to be moved to an opened position when the latch is removed from the first cavity.

### BRIEF DESCRIPTION OF THE DRAWINGS

The present invention will now be described, by way of example, with reference to the accompanying drawings, in which:

FIG. 1 is a side view of a door in a secure condition at a first door position within a door frame and having a portion of the door frame broken away to show an electric door strike;

FIG. 2 is a perspective view from the right front showing an electric door strike in accordance with the present invention showing a keeper in a closed position;

FIG. 3 is a perspective view of the electric door strike shown in FIG. 2 showing the keeper in an opened position;

FIG. 4 is a perspective view from the left front showing the electric strike shown in FIG. 3;

FIG. 5 is a top view of the electric strike shown in FIG. 3 with a back plate of the keeper removed to show a locking mechanism;

FIG. 6 is a top view similar to FIG. 5 with a portion of an outer body of the locking mechanism removed;

FIG. 7 is an exploded view of the keeper and the locking mechanism included in the electric strike;

FIG. 8A is a top view of the locking mechanism shown in an extended position;

FIG. 8B is a view similar to FIG. 8B with the locking mechanism in a retracted position; and

FIG. 9 is a bottom perspective view of the electric door strike including a fail-safe and fail-secure mode switch.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

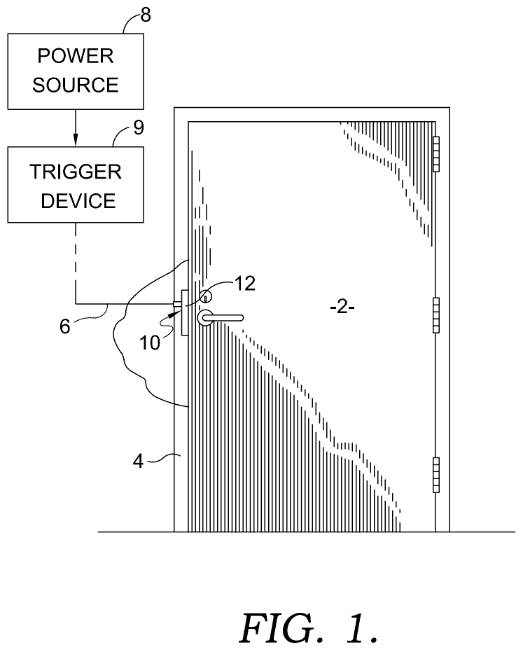

Referring initially to FIG. 1, a typical door 2 is shown in a closed position within a door frame 4. Door 2 may be pivotally mounted to door frame 4 so that door 2 is able to move between a closed position and an open position. An electric door strike 10 in accordance with the present invention may be positioned within a recess defined in door frame 4. As will be further described below, electric door strike 10 includes a housing 12, which is configured to accommodate electrical and mechanical components thereof. The electrical components in turn may be electrically in communication by means of wiring 6. Electric door strike assembly 10, for example, may be in communication with a power supply 8 such as, for example, battery power or a 12 or 24 volt circuit, which in turn may be hardwired to the external electric power grid where power supply 8 is configured to receive 115 VAC or 230 VAC line voltage. Electric door strike assembly 10 may be activated via a trigger device, such as a credential or authentication device 9. This credential device 9 is typically a switch whose contacts selectively actuate electric door strike assembly 10. The credential device 9, however, is often incorporated into a control entry device such as a card reader or digital entry keypad, where the actuator is activated after an authorized card is presented to the card reader (or an authorized code is entered into credential device 9).

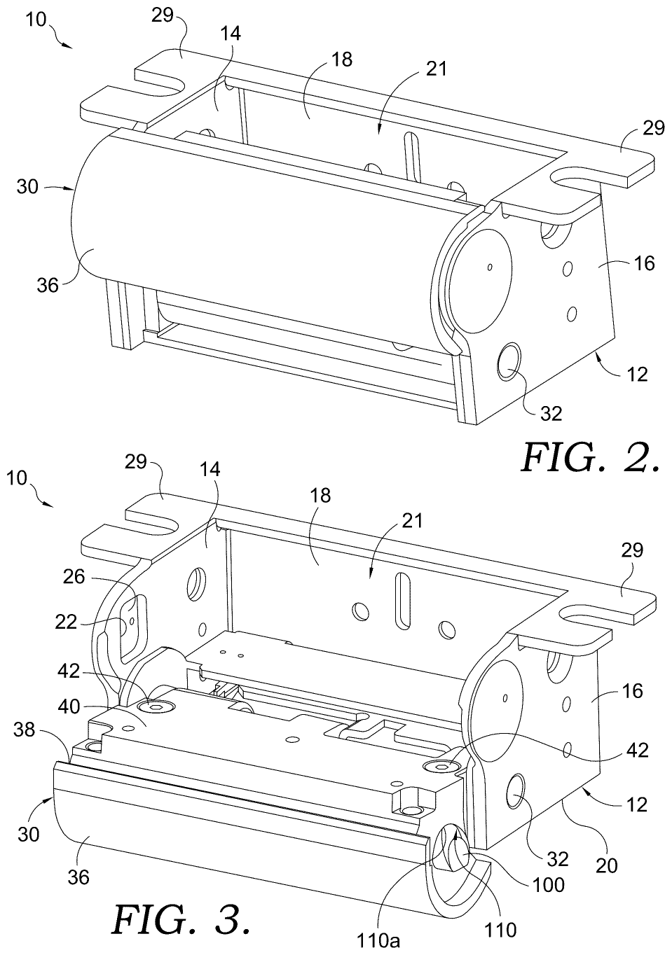

Referring now to FIGS. 2-4, electric door strike 10 includes housing 12 that is mountable to door frame 4. It should be understood that electric door strike 10 is to be regarded as exemplary in nature and does not serve to limit application of the present invention to embodiments solely thereto. The mounting of housing 12 may be either surface mounted or recessed mounted relative to door frame 4. Housing 12 may include a pair of opposing side walls 14, 16 with a rear wall 18 disposed therebetween. Side walls 14, 16 and rear wall 18, along with a bottom wall 20 of housing 12, define a cavity 21 adapted to receive a door latch associated with door 2. Further, each side wall 14, 16 has a recess 22, 24 defined therein. Each recess 22, 24 may extend all the way through its respective side wall 14, 16, or may be defined by an inner wall of a cap 26, 28. Cap 26, 28 may be removable relative to housing 12 or integrally formed therewith. Housing 12 may further include a pair of flanges 29 that allow a face plate (not shown) to be attached to housing 12.

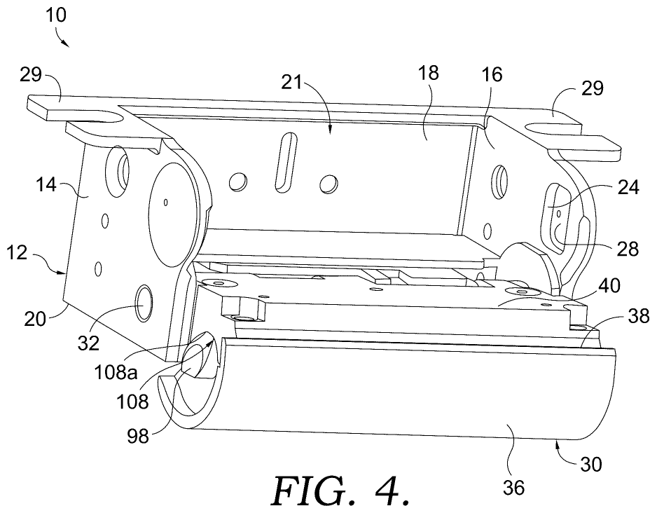

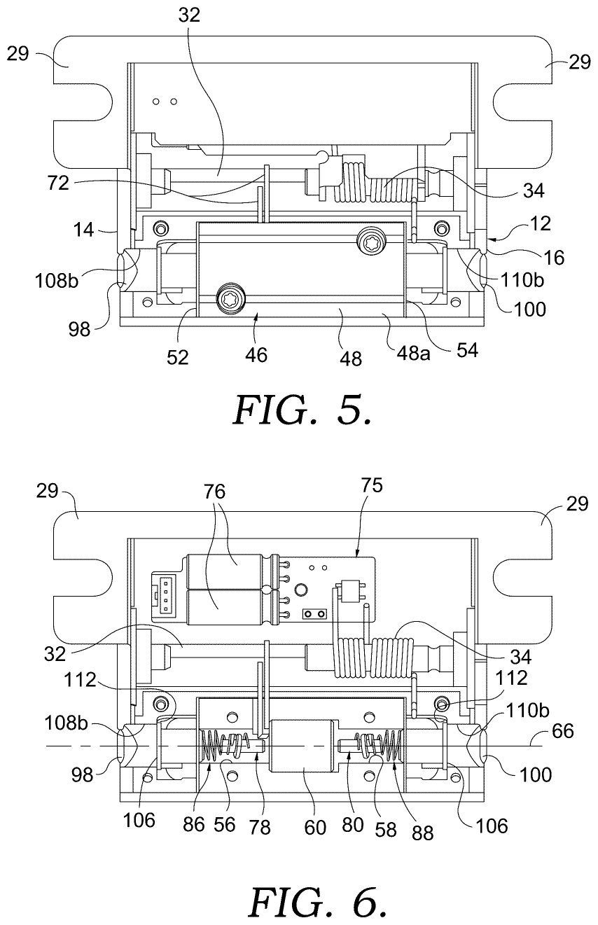

With continued reference to FIGS. 2-4, electric door strike 10 may further include a keeper 30 movably mounted to housing 12. For example, keeper 30 may be pivotally mounted to housing 12 about a shaft 32 so that keeper 30 can move between a closed position and an opened position. When in the closed position shown in FIG. 2, keeper 30 operates to retain a latch in cavity 21 to maintain the position of door 2 within door frame 4. Keeper 30 may be moved the opened position shown in FIGS. 3 and 4 when keeper is not engaged with housing 12 and the latch is removed from cavity 21 by opening door 2. As seen in FIGS. 5 and 6, a biasing mechanism 34 may be disposed between housing 12 and keeper 30 to bias keeper 30 to the closed position.

With reference to FIGS. 2-4 and 7, keeper 30 includes a ramp element 36 that is configured for engaging the latch as door 2 is being closed in door frame 4. As door 2 is being closed, ramp element 36 operates to retract the latch until the latch clears an upper edge 38 of ramp element 36, at which time the latch moves back to its extended position within cavity 21 of housing 12 so that door 2 is secured to door frame 4. Keeper 30 may further include a back plate 40 that is attached to ramp element 36 using one or more fasteners 42, wherein back plate 40 is configured for engaging the latch when keeper 30 is in the closed position and the latch is disposed in cavity 21. Further, a cavity 44 may be defined between ramp element 36 and back plate 40, which is configured for receiving a locking mechanism 46.

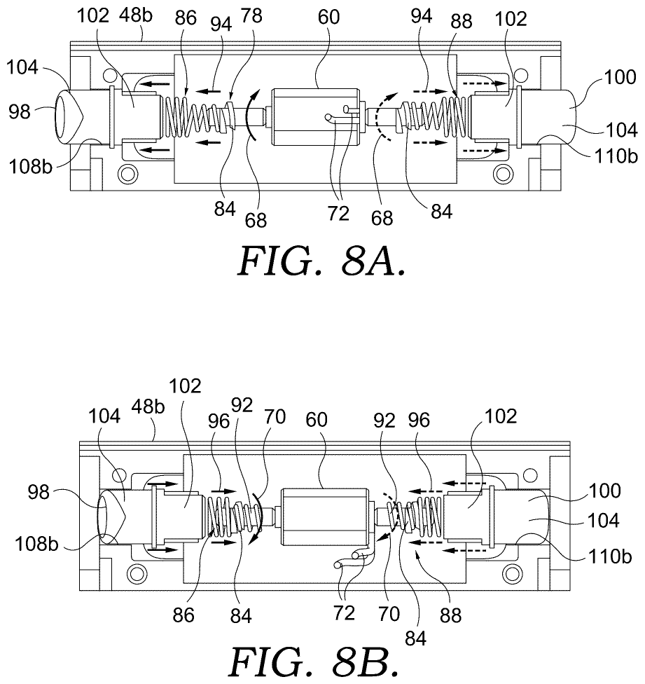

As best seen in FIGS. 5-7, locking mechanism 46 is coupled with keeper 30 and operates to selectively place keeper 30 in a locked state and an unlocked state relative to housing 12. At least a portion of locking mechanism 46 is configured to be disposed within cavity 44 formed between ramp element 36 and back plate 40. For example, locking mechanism 46 comprises an outer body 48 that may be formed as a clam-shell including two-pieces 48a, 48b that define a cavity 50. Outer body 48 further includes first and second ends 52, 54 having respective first and second channel openings 56, 58 defined therein. An actuator 60, such as a motor, is disposed in cavity 50 between first and second channel openings 56, 58. In an exemplary embodiment, a motor is used as an actuator because of its low power requirement (e.g., 0.36 watts), and also because it produces significantly less heat compared to a solenoid. Actuator 60 may include shaft disposed on a longitudinal axis 70, which may be, for example, a first shaft 62 and a second shaft 64. In an exemplary embodiment, longitudinal axis 70 may be parallel with shaft 32 of keeper 30. Actuator 60 is configured for rotating first and second shafts 62, 64 in a first rotational direction 68 (FIG. 8A) and a second rotational direction 70 (FIG. 8B) that is opposite of first rotational direction 68. Actuator 60 is electrically connected to power supply 8 and trigger device 9 via wires 72 and a connector 74 to selectively provide power to actuator 70 via a printed circuit board assembly (PCBA) 75 as will be discussed further below. Actuator 70 may further be electrically connected to at least one capacitor 76 (e.g., 1000 μf) disposed on PCBA 75 that operates to provide power to actuator 70 when a power failure occurs with power supply 8 such that power is not able to be provided to actuator 70 by power supply 8.

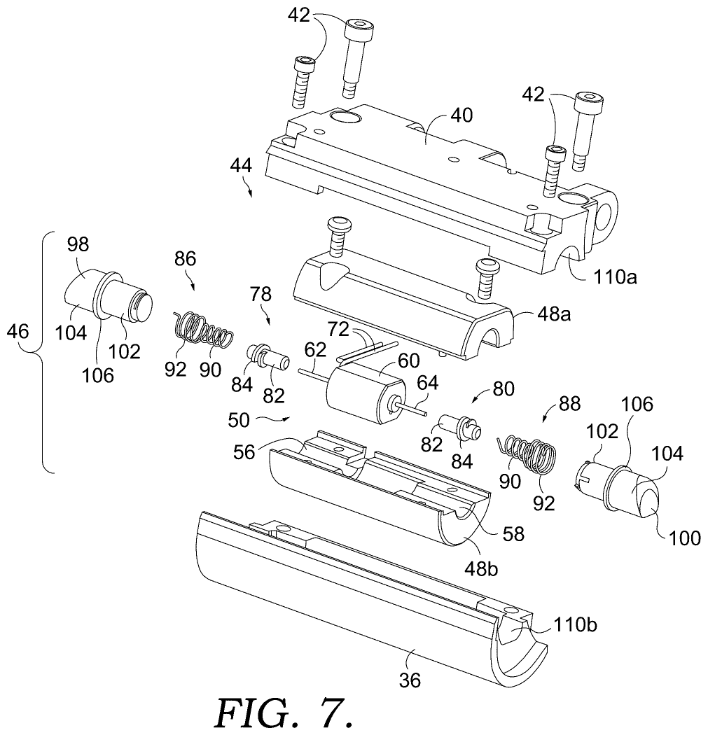

With reference to FIGS. 6 and 7, locking mechanism 46 further comprises first and second worm cams 78, 80 that are coupled with first and second shafts 62, 64, respectively. Therefore, when actuator 60 operates to rotate both first and second shafts 62, 64 in either first or second rotational direction 68, 70, the first and second worm cams 78, 80 also rotate in the same rotational direction about longitudinal axis 66. It should be understood that first and second worm cams 78, 80 may rotate at the same or different rate relative to first and second shaft 62, 64. Each of first and second worm cams 78, 80 may include a shaft portion that is configured to be coupled to respective first and second shafts 62, 64, and a worm portion 84.

Locking mechanism 46 further includes first and second resilient members, such as first and second springs 86, 88, that are operably associated with first and second worm cams 78, 80, respectively. First and second springs 86, 88 may be configured for being movably positioned in first and second channel openings 56, 58, respectively. Each of first and second springs 86, 88 may include a first end portion 90 and a second end portion 92. First end portion 90 of each spring 86, 88 is operably engaged with worm portion 84 of its respective worm cam 78, 80. In certain exemplary embodiments, first end portion 90 of each spring 86, 88 may have a first diameter that allows worm portion 84 of its respective worm cam 78, 80 to engage first portion 90.

For example, and with reference to FIG. 8A, when worm cam 78 is rotated in first rotational direction 68 by first shaft 62 of actuator 60, worm portion 84 of worm cam 78 engages first end portion 90 of spring 86 to move spring 86 linearly outwardly 94 within first channel opening 56 along longitudinal axis 66. Likewise, when worm cam 80 is rotated in first rotational direction 68 by second shaft 64 of actuator 60, worm portion 84 of worm cam 80 engages first end portion 90 of spring 88 to move spring 88 linearly outwardly 94 within second channel opening 58 along longitudinal axis 66. It should be understood that while springs 86, 88 are moving linearly outwardly relative to each other, worm cams 78, 80 are just rotated by respective shafts 62, 64 and not moving linearly. Further, while worm cams 78, 80 are described above as rotating in the same rotational direction 68, it should be understood that worm cams 78, 80 may also be rotated in opposite rotational directions depending on the orientation of the threads on worm cams 78, 80 so long as it results in springs 86, 88 moving linearly outwardly 94 relative to one another.

With reference to FIG. 8B, first end portion 90 of each spring 86, 88 is also operably engaged with worm portion 84 of its respective worm cam 78, 80 to move springs 86, 88 linearly towards 96 one another. For example, when worm cam 78 is rotated in second rotational direction 70 by first shaft 62 of actuator 60, worm portion 84 of worm cam 78 engages first end portion 90 of spring 86 to move spring 86 linearly inward 96 within first channel opening 56 along longitudinal axis 66. Likewise, when worm cam 80 is rotated in second rotational direction 70 by second shaft 64 of actuator 60, worm portion 84 of worm cam 80 engages first end portion 90 of spring 88 to move spring 88 linearly inwardly 96 within second channel opening 58 along longitudinal axis 66. Again, it should be understood that while springs 86, 88 are moving linearly inwardly relative to each other, worm cams 78, 80 are just rotated by respective shafts 62, 64 and not moving linearly. While worm cams 78, 80 are described above as rotating in the same rotational direction 70, it should be understood that worm cams 78, 80 may also be rotated in opposite rotational directions depending on the orientation of the threads on worm cams 78, 80 so long as it results in springs 86, 88 moving linearly inwardly 96 relative to one another.

In certain exemplary embodiments, second end portion 92 of each spring 86, 88 may have a second diameter that is greater than the first diameter of first end portion 90, wherein the second diameter is configured so that worm portion 84 of its respective worm cam 78, 80 disengages from first portion 90 to cease the inward linear travel of springs 86, 88 even if worm cam 78, 80 continues to rotate in second rotational direction 70.

With reference to FIGS. 3-7, locking mechanism 46 may further include at least one of first and second plungers 98, 100 that are configured for selectively placing keeper 30 in a locked state relative to housing 12 of electric door strike 10 when keeper 30 is in the closed position. Each plunger 98, 100 includes a first end 102 and a second end 104. First end 102 of each plunger 98, 200 is configured for being fixedly coupled with second end portion 92 of respective spring 86, 88, such that spring 86, 88 operates to bias and move each respective plunger 98, 100 in the same linear direction that spring 86, 88 is moved through the rotational movement of worm cam 78, 80. For example, as seen in FIG. 8B, when first spring 86 is moved linearly inward 96 as discussed above, the connection between second end portion 92 of first spring 86 and first end 102 of plunger 98 operates to bias plunger 98 inwardly toward a retracted position. Likewise, when second spring 88 is moved linearly inward 96 as discussed above, the connection between second end portion 92 of second spring 88 and first end 102 of plunger 100 operates to bias plunger 100 inwardly toward the retracted position. In an exemplary embodiment, springs 86, 88 will no longer produce an additional inward bias on plungers 98, 100 when first end portion 90 disengages from worm portion 84 of worm cam 78, 80 due to the increased diameter of second end portion 92 of spring 86, 88. Further, each plunger 98, 100 may include a collar 106 that is disposed between first end 102 and second end 104, and configured for engaging a respective first and second end 52, 54 of outer body 48 to set the inward travel limit of plungers 98, 100 in the retracted position.

Second end 104 of each plunger 98, 100 is configured for selectively placing keeper 30 in engagement with housing 12 to maintain keeper 30 in the closed position and retain the latch in cavity 21. Second end 104 of each plunger 98, 100 may be placed into engagement with keeper 30 when they are moved linearly outwardly 94 by springs 86, 88 when respective worm cams 78, 80 are rotated in first rotational direction 68 by actuator 60. In the exemplary embodiment shown in in FIGS. 5-7 and 8A, at least one of ramp element 36 and back plate 40 may define apertures 108, 110, such as a clam-shell 108a, 108b, 110a, 110b, that are configured to allow plungers 98, 100 to slide therein when moving between the extended position (FIG. 8A) and the retracted position (FIG. 8B). At least one of ramp element 36 and back plate 40 may further define a shoulder 112 on both ends thereof that are adapted to engage collar 106 of plunger 98, 100 to set the outer travel limit plungers 98, 100 when moving to the extended position, as seen in FIG. 6. When in the extended position as seen in FIGS. 5, 6 and 8A, plungers 98, 100 are configured to be disposed within respective recesses 22, 24 defined in side walls 14, 16 of housing 12 to place keeper 30 in a locked state relative to housing 12.

In operation, electric door strike 10 may be in the unlocked state as seen in FIG. 8B. In the unlocked position, keeper 30 is biased into the closed position by spring 34. In the unlocked state, a latch disposed in cavity 21 of housing 12 may be removed by moving the door 2 towards the opened position. When the door is moved to the opened position, the latch contacts back plate 40 and keeper 30 is able to rotate about shaft 32 to the position shown in FIGS. 3 and 4 because plungers 98, 100 are retracted (FIG. 8B) and not disposed in respective recesses 22, 24. After the latch is removed from housing 12, keeper 30 is biased back into the closed position by spring 34.

Electric door strike 10 may be placed in the locked state by placing plungers 98, 100 in the extended position within respective recesses 22, 24 so that keeper 30 is secured to side walls 14, 16 of housing 12. In order to place electric strike 10 in the locked state, power may be selectively provided to actuator 60 by power supply 8. When power is provided to actuator 60, actuator 60 operates to rotate shafts 62, 64 and worm cams 78, 80 in first rotational direction 68 as seen in FIG. 8A. Worm cams 78, 80 then operate to move springs 86, 88 linearly outwardly 94 away from each other along longitudinal axis 66 using worm portions 84. As springs 86, 88 are moving linearly outwardly 94, they operate to bias plungers 98, 100 toward the extended position shown in FIG. 8A. As mentioned above, the outward travel of plungers 98, 100 may be limited by the engagement of collar 106 with shoulder 112. In the extended position, plungers 98, 100 may be positioned within recesses 22, 24 to engage locking mechanism 96 with housing 12. Since locking mechanism 46 is mounted to keeper 30, plungers 98, 100 therefor operate to secure keeper 30 to housing 12 so that electric door strike 10 is in the locked state. In the locked state shown in FIGS. 2 and 8A, keeper 30 operates to maintain the latch disposed in cavity 21 so that door 2 s not able to be opened relative to door frame 4. It is also possible that electric strike 10 may be in the locked state and door 2 is in an open position. In this case, door 2 may be moved to the closed position shown in FIG. 1, and in doing so, ramp element 36 of keeper 30 operates to retract the latch as the door is being closed and allows the latch to be extended into cavity 21 after the latch clears the upper edge 38 of the keeper 30.

After plungers 98, 100 are placed in the extended position shown in FIG. 8A so that electric door strike 10 may be placed in the locked state, locking mechanism 46 may operate to retract plungers 98, 100 to place electric door strike in the unlocked state. In order to place electric strike 10 in the unlocked state, power may be selectively provided to actuator 60 by power supply 8 or the at least one capacitor 76. When power is provided to actuator 60, actuator 60 operates to rotate shafts 62, 64 and worm cams 78, 80 in second rotational direction 70 as seen in FIG. 8B. Worm cams 78, 80 then operate to move springs 86, 88 linearly inwardly 96 towards each other along longitudinal axis 66 using worm portions 84. As springs 86, 88 are moving linearly inwardly 96, they operate to bias plungers 98, 100 toward the retracted position shown in FIG. 8B. In the retracted position, plungers 98, 100 are no longer disposed in recesses 22, 24 of housing 12 and keeper 30 is able to move to the opened position shown in FIGS. 3 and 4 to allow the latch to been removed from cavity 21 when door 2 is opened relative to door frame 4.

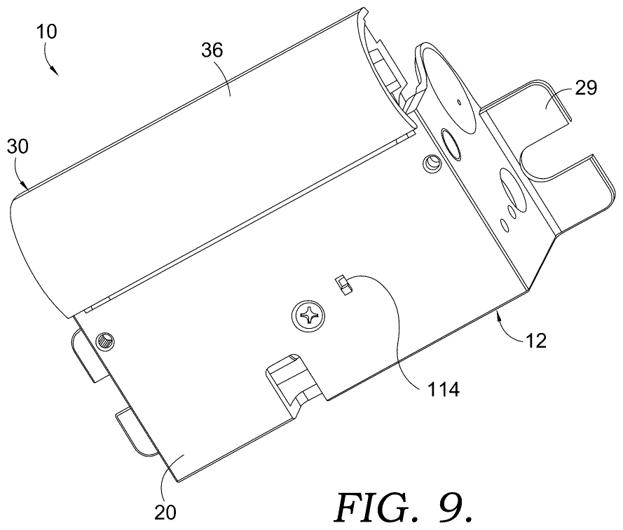

Electric strike 10 may be configured to be selectively placed in a fail-safe mode or a fail-secure mode using a mode selector 114 located on a secure side of the electric strike 10, as shown in FIG. 9. Mode selector 114 is electrically connected between the at least one capacitor 76 and actuator 60, and determines which rotational direction 68, 70 the actuator 60 will turn shafts 62, 64 if a power failure occurs to disconnect power supply 8 with actuator 60. When in the fail-safe mode, plungers 98, 100 in locking mechanism 46 will be placed in retracted position shown in FIG. 8B if actuator 60 is electrically disconnected from power supply 8. For example, if a power failure occurs and power supply 8 is not able to provide power to actuator 60, locking mechanism 46 would be placed in an initial starting position shown in FIG. 8B where plungers 98, 100 are retracted. So if a power failure occurs, door 2 will be able to be moved to the open position to allow for egress through door frame 4.

Alternatively, when in the fail-secure mode, plungers 98, 100 in locking mechanism 46 will be placed in extended position shown in FIG. 8A if actuator 60 is electrically disconnected from power supply 8. For example, if a power failure occurs and power supply 8 is not able to provide power to actuator 60, locking mechanism 46 would be placed in the initial starting position shown in FIG. 8A where plungers 98, 100 are extended and able to be positioned in recesses 22, 24 in housing 12 to secure the latch in cavity 21 and prevent door 2 from being opened relative to door frame 4. So if a power failure occurs, door 2 will not be able to be moved to the open position to allow for egress through door frame 4 once the latch is disposed in cavity 21.

As an alternative to using mode selector 114, the configuration of the electrical connections between electric door strike 2 and power supply 8 may be arranged to place electric door strike 10 in the fail-safe mode or the fail-secure mode. For example, wires 6 coming from electric door strike may comprise a first wire and a second that are connected to corresponding wires coming from power supply 8. In particular, one wire coming from the power supply may provide a positive voltage and the another wire may be connected to ground (negative). As described above, the setting of the position of mode switch 114 determines if electric door strike 10 behaves in the fail-secure mode or the fail-safe mode. The function of mode switch 114 could be replaced with how electric door strike 10 is wired to power supply 8. For example, if the first wire coming from electric door strike 10 is electrically connected to the positive voltage of power supply 8, and the second wire coming from electric door strike 10 is electrically connected to the ground wires coming from power supply 8, electric door strike 10 may behave in the fail secure mode. But if electric door strike 10 is desired to operate in a fail-safe mode, instead of flipping mode switch 114, the second wire coming from electric door strike 10 could be electrically connected to the positive voltage coming from power supply 8, and the first wire coming from electric door strike 10 may be electrically connected to the ground wire of power supply 8. The electric door strike 10 can be configured to detect which wire contains the positive voltage and would behave as either fail-secure or fail-safe based on that input signal.

In order to move locking mechanism 46 to the initial starting position when there is a power failure, one exemplary embodiment of electric strike 10 may utilize the at least one capacitor 76. In particular, during the normal operation of electric strike 10 when power supply 8 is still providing power to electric strike 10, power supply 8 operates to provide power to charge the at least one capacitor 76. Given that the at least one capacitor 76 is charged when failure of power supply 8 occurs, the at least one capacitor 76 is able to provide power to actuator 60 to allow actuator 60 move shafts 62, 64 and worm cams 78, 80 in the appropriate rotational direction to move springs 86, 88 to place plungers 98, 100 in the initial starting position. Therefore, if the mode selector 114 is set in the fail-safe mode, then the at least one capacitor 76 would provide power to actuator 60 to place plungers 98, 100 in the retracted position shown in FIG. 8B. If the mode selector 114 is set in the fail-secure mode, then the at least one capacitor 76 would provide power to actuator 60 to place plungers 98, 100 in the extended position shown in FIG. 8A. In either case, the use of actuator 60 in the form of a motor that has a relative low power requirement for operation (e.g., 0.36 watts) allows for the use of at least one capacitor 76 to move plungers 98, 100 to their initial starting position if power failure occurs with respect to power supply 8.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims. Furthermore, relative positional or directional terms used herein, such as for example, top, bottom, front, back, left side, right side, upward, downward, rightward, leftward, inward, outward, vertical, horizontal, clockwise, counterclockwise, etc., may have been used in the above-referenced description to describe a positional or directional relationship among elements as the elements are presented in the drawings. However, these terms should not limit in any way a specific orientation of the referenced feature, in practice. For example, a top wall as depicted in a drawing may be thought of as a side or bottom wall if the element is oriented differently in practice.

Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A locking mechanism for an electric strike for operating in conjunction with a latch of a lockset, the locking mechanism comprising:
an outer body including a first end and a second end, wherein the outer body defines a cavity, and wherein the outer body includes a first opening defined in the first end and a second opening defined in the second end;
an actuator disposed within the cavity, wherein the actuator includes at least one shaft, and wherein the actuator is configured for rotating the at least one shaft;
a first worm cam coupled with the at least one shaft;
a second worm cam coupled with the t least one shaft;
a first plunger;
a second plunger;
a first resilient member having a first end portion and a second end portion, wherein the first resilient member is movably positioned within the first opening, wherein the first end portion of the first resilient member is operably engaged with the first worm cam, and wherein the second end portion of the first resilient member is fixedly coupled with the first plunger; and
a second resilient member having a first end portion and a second end portion, wherein the second resilient member is movably positioned within the second opening, wherein the first end portion of the second resilient member is operably engaged with the second worm cam, and wherein the second end portion of the second resilient member is fixedly coupled with the second plunger;
wherein when the actuator rotates the at least one shaft in a first rotational direction, the first worm gear and the second worm gear move the respective first resilient member and the second resilient member towards one another to thereby place the first plunger and the second plunger in a retracted position, and
wherein when the actuator rotates the at least one shaft in a second rotational direction opposite of the first rotational direction, the first worm gear and the second worm gear move the respective first resilient member and the second resilient member away from one another to thereby place the first plunger and the second plunger in an extended position.

2. The locking mechanism in accordance with claim 1, wherein the first plunger and second plunger travel along a common linear path when moving between the retracted position and the extended position.

3. The locking mechanism in accordance with claim 1, wherein the at least one shaft has an axis of rotation, and wherein the first plunger and second plunger travel linearly along the axis of rotation when moving between the retracted position and the extended position

4. The locking mechanism in accordance with claim 1, wherein the first plunger extends beyond the first end of the outer body when in the extended position, and wherein the second plunger extends beyond the second end of the outer body when in the extended position.

5. The locking mechanism in accordance with claim 1, wherein the actuator is a motor.

6. The locking mechanism in accordance with claim 1, wherein at least one of the first resilient member and the second resilient member is a coil spring.

7. The locking mechanism in accordance with claim 6, wherein the first end portion of the first resilient member has a first diameter, wherein the second end portion of the first resilient member has a second diameter, and wherein the first diameter of the first resilient member is less than the second diameter of the first resilient member.

8. The locking mechanism in accordance with claim 7, wherein the first end portion of the second resilient member has a first diameter, wherein the second end portion of the second resilient member has a second diameter, and wherein the first diameter of the second resilient member is less than the second diameter of the second resilient member.

9. The locking mechanism in accordance with claim 1, further comprising:
a power source electrically connected to the actuator; and
at least one capacitor electrically connected to the actuator,
wherein the first plunger and the second plunger each have an initial starting position that is one of the extended position or the retracted position,
wherein when the power source is electrically disconnected to the actuator, the at least one capacitor is configured to provide power to the actuator to place the first plunger and the second plunger in the initial starting position.

10. The locking mechanism in accordance with claim 1, further comprising a mode selector configured to place the locking mechanism in a fail-safe mode or a fail-secure mode, wherein the locking mechanism is in the fail-secure mode when the initial starting position is the extended position, and wherein when the initial starting position is the retracted position.

11. An electric strike for operating in conjunction with a latch of a lockset, the electric strike comprising:
a) a housing including an inner wall, wherein the inner wall defines a first cavity configured for receiving the latch, and wherein a first recess and a second recess are defined in the inner wall;
b) a keeper mounted to the housing and movable between a closed position and an opened position, wherein the keeper is configured for retaining the latch in the first cavity when in the closed position;
c) a locking mechanism coupled to the keeper, wherein the locking mechanism comprises:
i) an outer body including a first end and a second end, wherein the outer body defines a second cavity, and wherein the outer body includes a first opening defined in the first end and a second opening defined in the second end;
iii) an actuator disposed within the second cavity, wherein the actuator includes at least one shaft, and wherein the actuator is configured for rotating the at least one shaft;
iv) a first worm cam coupled with the at least one shaft;
v) a second worm cam coupled with the at least one shaft;
vi) a first plunger;
vii) a second plunger;
viii) a first resilient member having a first end portion and a second end portion, wherein the first resilient member is movably positioned within the first opening, wherein the first end portion of the first resilient member is operably engaged with the first worm cam, and wherein the second end portion of the first resilient member is fixedly coupled with the first plunger; and
ix) a second resilient member having a first end portion and a second end portion, wherein the second resilient member is movably positioned in the second opening, wherein the first end portion of the second resilient member is operably engaged with the second worm cam, and wherein the second end portion of the second resilient member is fixedly coupled with the second plunger,
wherein when the actuator rotates the at least one shaft in a first rotational direction, the first worm gear and the second worm gear move the respective first resilient member and the second resilient member towards one another to thereby place the first plunger and the second plunger in a retracted position so that the first plunger and the second plunger are not engaged with the respective first recess and the second recess to thereby allow the keeper to move to the opened position when the latch is moved out of the first cavity, and
wherein when the actuator rotates the at least one shaft in a second rotational direction opposite of the first rotational direction, the first worm gear and the second worm gear move the respective first resilient member and the second resilient member away from one another to thereby place the first plunger and the second plunger in an extended position so that the first plunger and the second plunger are in a position to engage with the respective first recess and the second recess to maintain the keeper in the closed position.

12. The electric strike in accordance with claim 11, wherein the first plunger and second plunger travel along a common linear path when moving between the retracted position and the extended position.

13. The electric strike in accordance with claim 11, wherein the at least one shaft has an axis of rotation, and wherein the first plunger and second plunger travel linearly along the axis of rotation when moving between the retracted position and the extended position

14. The electric strike in accordance with claim 11, wherein the first plunger extends beyond the first end of the outer body when in the extended position, and wherein the second plunger extends beyond the second end of the outer body when in the extended position.

15. The electric strike in accordance with claim 11, wherein the actuator is a motor.

16. The electric strike in accordance with claim 11, wherein at least one of the first resilient member and the second resilient member is a coil spring.

17. The electric strike in accordance with claim 16, wherein the first end portion of the first resilient member has a first diameter, wherein the second end portion of the first resilient member has a second diameter, and wherein the first diameter of the first resilient member is less than the second diameter of the first resilient member.

18. The electric strike in accordance with claim 17, wherein the first end portion of the second resilient member has a first diameter, wherein the second end portion of the second resilient member has a second diameter, and wherein the first diameter of the second resilient member is less than the second diameter of the second resilient member.

19. The electric strike in accordance with claim 11, further comprising:
a power source electrically connected to the actuator; and
at least one capacitor electrically connected to the actuator,
wherein the first plunger and the second plunger each have an initial starting position that is one of the extended position or the retracted position,
wherein when the power source is electrically disconnected to the actuator, the at least one capacitor is configured to provide power to the actuator to place the first plunger and the second plunger in the initial starting position.

20. The electric strike in accordance with claim 11, further comprising a mode selector configured to place the locking mechanism in a fail-safe mode or a fail-secure mode, wherein the locking mechanism is in the fail-secure mode when the initial starting position is the extended position, and wherein when the initial starting position is the retracted position.

21. The electric strike in accordance with claim 11, wherein the inner wall includes a first side wall, a second side wall, and a back wall connecting the first side wall and the second side wall, wherein the first recess is defined in the first side wall, and wherein the second recess is defined in the second side wall.

22. A method of operating an electric strike for use in conjunction with a latch of a lockset, wherein the electric strike includes a housing that defines a first cavity configured for receiving the latch, and wherein the electric strike includes a keeper movably mounted to the housing and configured for being positioned in a closed position to selectively retain the latch in the first cavity, wherein the method includes:
a) providing a locking mechanism coupled with the keeper, wherein the locking mechanism comprises:
i) an outer body including a first end and a second end, wherein the outer body defines a second cavity, and wherein the outer body includes a first opening defined in the first end and a second opening defined in the second end,
iii) an actuator disposed within the second cavity, wherein the actuator includes at least one shaft, and wherein the actuator is configured for rotating the at least one shaft,
iv) a first worm cam coupled with the at least one shaft,
v) a second worm cam coupled with the at least one shaft,
vi) a first plunger,
vii) a second plunger,
viii) a first resilient member having a first end portion and a second end portion, wherein the first resilient member is movably positioned within the first opening, wherein the first end portion of the first resilient member is operably engaged with the first worm cam, and wherein the second end portion of the first resilient member is fixedly coupled with the first plunger, and
ix) a second resilient member having a first end portion and a second end portion, wherein the second resilient member is movably positioned in the second opening, wherein the first end portion of the second resilient member is operably engaged with the second worm cam, and wherein the second end portion of the second resilient member is fixedly coupled with the second plunger;
b) rotating the at least one shaft in a first rotational direction using the actuator to thereby rotate the first worm cam and the second worm cam, respectively, in the first rotational direction; and
c) moving the first resilient member and the second resilient member along a linear path away from each other to move the first plunger and the second plunger in an extended position to engage the keeper with the housing to maintain the keeper in the closed position.

23. The method recited in claim 22, further comprising the steps of:
rotating the at least one shaft in a second rotational direction using the actuator to thereby rotate the first worm cam and the second worm cam, respectively, in the second rotational direction, wherein the second rotational direction is opposite of the first rotational direction; and
moving the first resilient member and the second resilient member along the linear path towards each other to move the first plunger and the second plunger in a retracted position to disengage the keeper from the housing and allow the keeper to be moved to an opened position when the latch is removed from the first cavity.

24. The method recited in claim 23, wherein the first plunger and the second plunger each have an initial starting position that is one of the extended position or the retracted position, wherein the method further comprises:
providing power to the actuator using at least one capacitor to place the first plunger and the second plunger in the initial starting position when a power source is electrically disconnected to the actuator.

25. The method recited in claim 24, further comprising the step of selectively switching the locking mechanism between a fail-safe mode and a fail-secure mode, wherein the locking mechanism is in the fail-secure mode when the initial starting position is the extended position, and wherein when the initial starting position is the retracted position.

26. The method recited in claim 25, wherein the step of selectively switching the locking mechanism between the fail-safe mode and the fail-secure mode includes switching electrical connections between a positive lead and a negative lead of the power supply with corresponding wires associated with the electric door strike.

27. The method recited in claim 22, wherein the at least one shaft is a first shaft and a second shaft.
